(19) United States
(12) Patent Application Publication
(10) Pub. No.: US 2009/0064674 A1
(43) Pub. Date: Mar. 12, 2009

(54) Accumulator

(76) Inventor: Per-Olof Davidsson, Limhamn (SE)

Correspondence Address: ST. ONGE STEWARD JOHNSTON & REENS, LLC, 986 BEDFORD STREET, STAMFORD, CT, 06905-5619, US

(21) Appl. No.: 12/207,830

(22) Filed: Sep. 10, 2008

Related U.S. Application Data
(63) Continuation of application No. PCT/EP2007/050565, filed on Jan. 19, 2007.

(30) Foreign Application Priority Data
Mar. 10, 2006 (SE) 0600524-3

(51) Int. Cl. F16L 55/04; F16D 31/02

(52) U.S. Cl. 60/422; 138/31; 180/383

(57) ABSTRACT

An accumulator for a hydraulic system, wherein the accumulator comprises a liner, a piston and a housing, that defines a pressure chamber, for receiving hydraulic fluid at high pressure, wherein the piston is biased towards an end position of the pressure chamber for interacting with the hydraulic fluid in the pressure chamber, and the piston is movable in a predetermined range for accumulating hydraulic fluid. The accumulator has at least one outlet port in a sidewall of the liner, which outlet port is covered by the piston in the predetermined range and is uncovered when the piston has moved a predetermined distance from the end position. A hydraulic system is also provided that comprises the above accumulator and an all-wheel drive system comprising the above hydraulic system. A method for de-airing an accumulator according to above is also provided.

### CROSS-REFERENCE TO RELATED APPLICATIONS

The present application is a continuation of pending International patent application PCT/EP2007/050565 filed on Jan. 19, 2007 which designates the United States and claims priority from Swedish patent application 0600524-3 filed on Mar. 10, 2006, the content of which is incorporated herein by reference.

### FIELD OF THE INVENTION

The present invention relates to an accumulator for a hydraulic system and a method of de-airing a hydraulic system comprising such an accumulator. It furthermore relates to a hydraulic system and an all-wheel drive system incorporating said hydraulic system.

### BACKGROUND OF THE INVENTION

Hydraulic systems are normally equipped with a pump that provides high-pressure oil to actuators and control valves. An accumulator can be connected to the high-pressure side where it inter alia can serve to remove pressure fluctuations in the hydraulic system. The pressure at the high-pressure side should be limited, though, and this is traditionally done by providing a pressure-overflow valve, which opens at a set pressure. Due to the large tolerances that normally exist for the pressure in the accumulator and for the opening pressure of the pressure-overflow valve, the preset opening pressure of the pressure-overflow valve must be set at a level that is much higher than the nominal pressure when the accumulator is filled. This may result in an unnecessarily high load being imposed on the pump and the motor, as the pump will pump against a filled accumulator.

### SUMMARY OF THE INVENTION

It is an object of the present invention to mitigate, alleviate or eliminate one or more of the above-identified deficiencies and disadvantages singly or in any combination. This is in one aspect achieved by an accumulator for a hydraulic system, wherein the accumulator comprises a liner, a piston and a housing, defining a pressure chamber, for receiving hydraulic fluid at high pressure, wherein the piston is biased towards an end position of the pressure chamber for interacting with the hydraulic fluid in the pressure chamber, and the piston is movable in a predetermined range for accumulating hydraulic fluid. The accumulator furthermore has at least one outlet port in a sidewall of the liner which outlet port is covered by the piston in said predetermined range and is uncovered when the piston has moved a predetermined distance from the end position. In one embodiment, the liner around the pressure chamber may be made of a polymeric material, such as poly phenylene sulfide. In another embodiment, the accumulator further comprises a passage in order to interconnect the low-pressure chamber with a low-pressure side of the accumulator. In yet another embodiment, the accumulator further comprises a passage that interconnects the low-pressure chamber with a reservoir. In still another embodiment, the accumulator further comprises a spring at a low-pressure side of the accumulator, for biasing the piston towards a top end position in the pressure chamber. In another embodiment, the accumulator further comprises a drain of a control component, which drain is connected to a low-pressure side of the accumulator. In yet another embodiment, the accumulator further comprises a spillway overflow at a low-pressure side of the accumulator between an interior of the accumulator and a channel leading to a reservoir. In still another embodiment, the at least one outlet port of the accumulator has a diameter that is smaller than a width of a piston ring of the piston.

In a second aspect of the invention, a hydraulic system comprises a hydraulic pump, a control component and a hydraulic actuator, wherein the system further comprises an accumulator according to any previous embodiment.

In a third aspect, an all-wheel drive coupling comprises a hydraulic system according to the second aspect.

In a fourth aspect, a method is provided for de-airing a hydraulic system comprising an accumulator according to the first aspect. The method comprises the steps of closing associated hydraulic control valves, and operating a hydraulic pump for a predetermined time period, for emptying the accumulator of substantially all air.

### BRIEF DESCRIPTION OF THE DRAWINGS

The accumulator of the present invention will be more readily understood by reading the following detailed description in combination with the appended non-limiting drawings, where

FIG. 1 is a sectional view of an accumulator according to the invention,

FIG. 2 is a plan view of parts of the accumulator according to FIG. 1, and

FIG. 3 is a schematical view of a hydraulic system including an accumulator according to the invention.

### DETAILED DESCRIPTION OF THE INVENTION

Below, several embodiments of the invention will be described with references to the drawings. These embodiments are described for illustrative purposes only, in order to enable a skilled person to carry out the invention and to disclose the best mode. However, such embodiments do not limit the invention. Moreover, other combinations of the different features are possible within the scope of the invention.

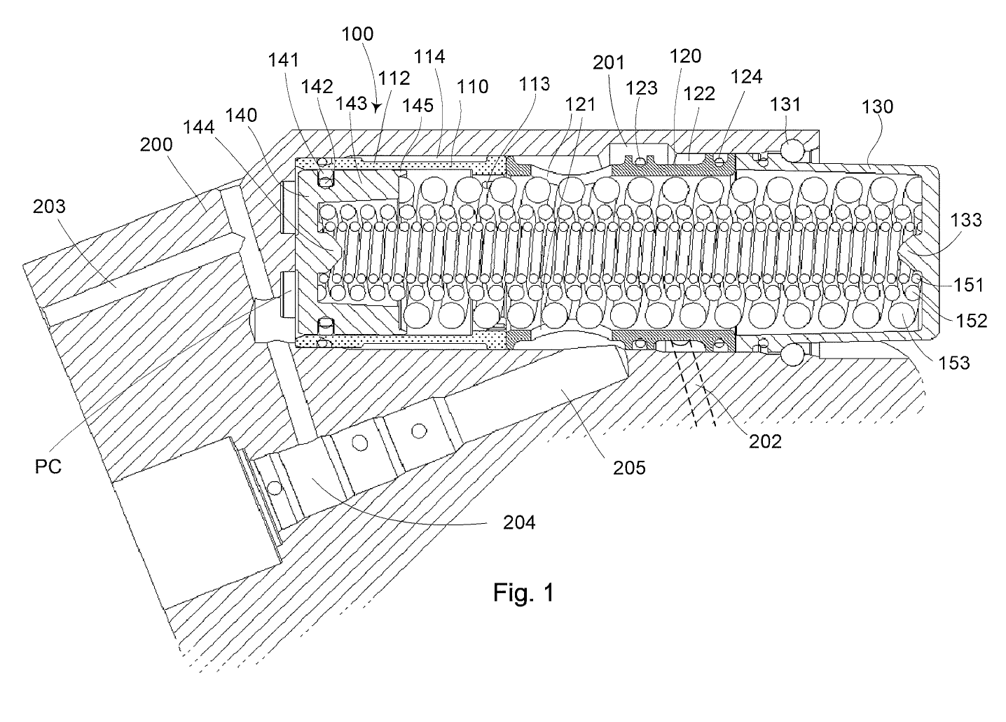

An accumulator 100 according to an embodiment of the present invention is shown in a sectional view in FIG. 1, mounted in a housing 200. The accumulator 100 includes, in the shown embodiment, a body comprising three parts, namely a liner 110, a spacer 120 and a lid 130, all being substantially cylindrical having a substantially circular cross-section. The liner 110 cooperates with a piston 140, which is adapted for reciprocating movement within the liner 110.

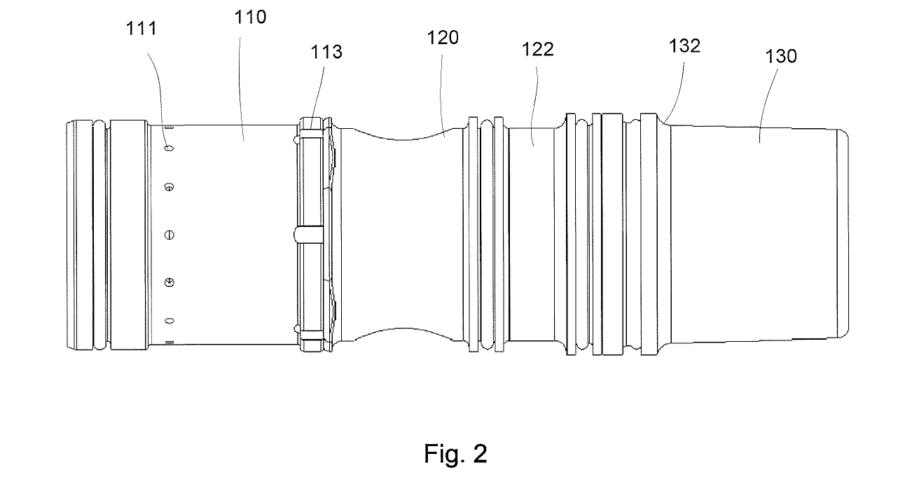

The liner 110 is formed with one or several outlet ports 111, see FIG. 2, which are located in a sidewall 112 of the liner 110. The ports 111 are generally placed at the same distance from a top of the liner 110. Furthermore, the liner 110 may have one or several inlet channels 113, which are located at a bottom part of the liner (one can be seen in FIG. 1). These channels 113 extend from the outside surface to the inside surface of the liner 110. In order to reduce the risk of burrs forming at the outlet ports 111, the liner 110 can be made from a polymeric material, such as PPS (poly phenylene sulfide), which should be possible to precision mould to tight tolerance.

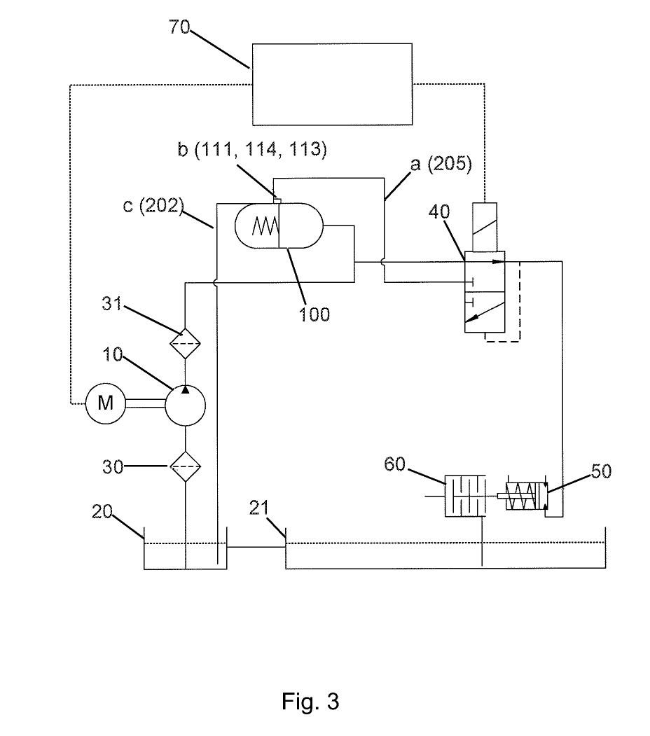

The spacer 120 can in one embodiment be provided with one or several holes 121 in a sidewall, and these serve to open a passage from the outside to the inside of the accumulator and vice versa. The bottom part of the spacer 120, in use, may comprise a channel 122 on its outside, which channel is enclosed by O-rings 123, 124 located in matching peripheral grooves. The O-rings seal off the channel 122 against the housing 200. A recess 201 in the surrounding housing 200 provides a passage from the interior of the accumulator 100 through the hole 121 to the channel 122. The recess 201 is located in the generally upper part of the housing 200, when the accumulator 100 is mounted in a use position, and thus forms a spillway overflow. The channel 122 can be in communication with a discharge line 202, which line 202 communicates with a first reservoir 20 (FIG. 3).

The piston 140 may in one embodiment be provided with a piston ring 141 of a suitable material, such as PTFE (Teflon®), which ring is housed in a circumferential groove in the piston 140. An O-ring 142 located radially inside of the piston ring 141 in the groove can stabilize the piston ring 141. The piston 140 may in one embodiment have a peripheral sidewall 143 that extends from the top towards the bottom, forming a cavity at the center of the piston 140. In the shown embodiment, the piston 140 can further be equipped with a central protrusion 144 on a lower (right) side, which is used for guiding a central compression spring 151, and the sidewall 143 can have a skirt 145 at its bottom outer periphery for guiding an outer compression spring 153. The central cavity can be adapted for accommodating one or several compression springs 151, 152, 153. A person skilled in the art can replace the three compression springs with any spring means that will bias the piston towards a top end position.

The liner 110, with the piston 140, and the spacer 120 are placed inside the housing 200, which is formed with channels and cavities for a connected hydraulic system. The liner 110, the piston 140 and the housing 200 define a pressure chamber where high-pressure fluid can be accommodated. A chamber 114 is formed radially outside of the liner 110, between the liner and the housing 200. The springs 151, 152, 153 are placed inside the liner 110 and the spacer 120 and the lid 130 is pressed against the force of the springs until the lid 130 contacts the spacer. The lid 130 is then secured by some retaining means, such as tangential retainer pins 131, that acts on a flange 132 on the lid, see FIG. 2. The springs 151, 152, 153 bias the piston 140 towards a top end position, defined by the housing 200, and shown in FIG. 1. The lid may also be formed with a central protrusion 133, for receiving a spring. Even though three springs are shown, it will be evident to a person skilled in the art that other spring configurations are possible, as mentioned above, and a gas spring is also possible.

The inlet port(s) 111 may in one embodiment have a diameter, or size of the port in the longitudinal direction, that is smaller than the width of the piston ring 141. This might reduce damage to the piston ring 141 from the inlet port(s) 111, as the piston ring 141 is depressed past the inlet port(s) 111.

The housing 200 accommodating the accumulator 100 may in one embodiment be formed with a channel 203 that is connected with a hydraulic pump 10, see FIG. 3, at one end and the top of the accumulator at the other end. A receiving hole 204 is provided for a control valve 40, which is connected to the hydraulic pump 10 and the accumulator 100 at one end and a hydraulic actuator 50 at another end, when the control valve 40 is set to activate the actuator 50. The receiving hole 204 is connected to a drain 205, where hydraulic fluid is discharged from the control valve. The drain 205 is in fluid communication via the hole 121 of the spacer with the interior of the accumulator 100.

The control valve 40 discharges fluid via a drain 205 in fluid communication with the interior of the accumulator 100, when the control valve is set to deactivate the hydraulic actuator 50. The amount of fluid inside the accumulator increases and eventually the accumulator is filled with fluid. Any additional fluid will be discharged via the recess 201, forming the spillway overflow, to the channel 122. The channel 122 communicates with a designated reservoir 20 via the discharge line 202, and the pump can then use the fluid again. The accumulator will then always be filled with substantially the same amount of hydraulic fluid, both in rest and in operation. This minimizes the changes of the fluid level in the reservoir 20, since the accumulator 100 will serve as an additional reservoir. Some change is probably inevitable, e.g. due to elasticity of the hydraulic system.

A hydraulic system is shown in FIG. 3, where an accumulator 100 of the present invention can be fitted. In this type of system, the same hydraulic fluid is normally used for the hydraulics as for lubrication and cooling of actuators, clutches and differential brakes. This means that hydraulic fluid gets polluted during normal operation, especially inside components subject to wear, such as the clutch and differential brake, and this pollution or debris is normally removed in a sieve and a filter. Too much debris may risk clogging the sieve and filter, though, and this should be avoided. This is done by utilizing a spring side (or low-pressure side) of the accumulator 100 as a way of minimizing the fluid circulation, from clean areas to polluted areas.

The hydraulic system comprises in the shown embodiment an electrically driven hydraulic pump 10, which draws hydraulic fluid from a first reservoir 20. The fluid passes a sieve 30 before the pump and a filter 31 after the pump and the fluid is then supplied to a hydraulic control valve 40. An accumulator 100 is also connected to the pump 10 and the inlet side of the hydraulic control valve 40. The control valve is in turn connected to a hydraulic cylinder 50 that is coupled to e.g. a clutch 60 for engaging an all-wheel drive coupling. The hydraulic cylinder and the control valve drain off fluid to a spring side of the accumulator 100 through pipe a, via the control valve 40. The accumulator has a bypass passage b (111, 114 and 113 in FIGS. 1 and 2), which leads fluid from a high-pressure side to a low-pressure side of the accumulator. This passage b limits the pressure on the high-pressure side of the system. When the spring side of the accumulator 100 is full, surplus fluid is drained via a spillway overflow, 201 in FIG. 1, through line c to the reservoir 20. An electronic controller 70, such as an ECU, controls the operation of the pump 10 and the hydraulic control valve 40. An additional reservoir 21 is arranged, which may be in fluid communication with the first reservoir 20 and the clutch 60. The actuator of the above system can be replaced by another device, such as a differential brake, that also pollutes the hydraulic system.

When the hydraulic system is operating, the hydraulic pump 10 supplies pressurized fluid to the channel 203. This channel transfers the fluid to the control valve 40 and to the top of the accumulator 100. When a certain fluid pressure has been reached, the force on the piston 140 from the fluid pressure surpasses that of the springs 151, 152, 153 and the piston 140 is pushed towards the bottom (to the right in FIG. 1). The travel of the piston is determined by the fluid pressure (and the spring force that the fluid pressure opposes), and the maximum pressure is obtained when the piston reaches its bottom end position. When the piston ring 141 now is moved past the outlet ports 111 in the liner 110, fluid is brought from the top side of the accumulator 100 via the outlet ports 111 to the chamber 114 outside of the liner 110. From there it may in one embodiment be brought to the low-pressure side of the accumulator via the inlet slots 113. The pressure decreases above the piston 140 and the springs 151, 152, 153 push the piston so that the piston ring 141 again closes off the outlet ports 111. The inlet slots 113 could be replaced by a drain (not shown) that leads from the chamber 114 to the reservoir 20, or by ports similar to the outlet ports 111.

In FIG. 1, the housing 200 is shown as a large block-like component that also has channels and holes for an associated hydraulic system, and the housing also accommodates the control valve 40. The housing can instead be a separate item, which mainly functions to seal off the upper part of the pressure chamber PC and forms the low-pressure chamber 113 on an outside of the liner 110. The housing can hence be manufactured of a thin metal plate, and mainly be configured to accommodate the accumulator 100. The housing can comprise one, two or more portions.

The present invention is described as a specific embodiment, but can just as well be any accumulator that can deliver hydraulic fluid at a working pressure, and which accumulator is refilled by an intermittently or continuously driven pump. The accumulator should be provided with holes or channels that are opened at a certain pressure in the pressure chamber of the accumulator, as a consequence of a piston uncovering at least one port in a liner of the accumulator, and the fluid being supplied to a low-pressure side of the accumulator or to a reservoir. The low-pressure side can also be supplied with other drains of clean hydraulic fluid, for introducing a system with clean fluid that is separated from a system with polluted fluid.

The object of the present invention can also be achieved in other ways. In one alternative embodiment, the piston is rotatably arranged about a longitudinal axis of the accumulator. The piston can be biased by a torsion spring that forces the piston towards an end position, where the volume of the pressure chamber is minimal. The piston is rotated by the hydraulic fluid to a position where the outlet port(s) is uncovered, for limiting the pressure in the pressure chamber.

In one embodiment, the liner 110 comprises at least one outlet port 111 in a sidewall 112 of the liner 110, which outlet port 111 is adapted to allow hydraulic fluid to flow from the pressure chamber PC to a low-pressure chamber 114, when the piston 140 has been depressed past the outlet port 111, in order to limit the pressure in the pressure chamber PC.

In one embodiment of the present invention, a method can be used for de-airing an accumulator 100 in a hydraulic system. This is achieved by operating the pump 10 that supplies hydraulic fluid to the accumulator 100, up to a pressure where the piston 140 in the accumulator 100 uncovers the outlet port(s) 111 of the liner 110. In this way, substantially all of the air in the pressure chamber PC in the accumulator 100 is forced out with some of the hydraulic fluid. The pressure can be kept at a high level for a predetermined time, for ensuring that virtually all air is forced out of the pressure chamber PC. The pump 10 can then be operated in another way that suits the demands of the associated hydraulic system.

The above-mentioned hydraulic fluid can be any suitable fluid, such as hydraulic oil, mineral oil, water, glycol ethers, rapeseed-based hydraulic oil etc, depending on the operating characteristics of the associated hydraulic system.

The accumulator of the present invention leads to several advantages over prior art, such as very fast response, since the accumulator functions as a capacitor in an electric circuit, almost unlimited delivery time of nearly maximum hydraulic pressure, if an intermittently operated pump interacts with the accumulator, and the possibility of reducing the pump size, if intermittent operation and reduced maximum pressure is utilized. The last effect comes from the built-in pressure reduction in the accumulator, which prevents the pump from pumping against a filled accumulator, until the pressure-overflow valve has opened.

Even though the present invention is mentioned in relation to an all-wheel drive system, it will be evident for a person skilled in the art to incorporate an accumulator of the invention in another hydraulic environment, for obtaining the same advantages.

References to right and left are merely made for illustrative purposes and are to be interpreted together with the drawings. Top refers to the piston side of the accumulator and bottom to the lid side. It is also used for determining relative position on a specific part, meaning in the direction towards the top or bottom, respectively.

1. An accumulator for a hydraulic system, the accumulator comprising
a housing, a liner immovably provided therein, and a piston reciprocally arranged in the liner,
a pressure chamber for receiving hydraulic fluid at high pressure being formed by the liner, the piston, and the housing,
wherein the piston is biased towards an end position in the pressure chamber for interacting with the hydraulic fluid in the pressure chamber, said piston being reciprocally movable in a predetermined range for accumulating hydraulic fluid,
characterized by at least one outlet port in a sidewall of the liner, which outlet port is covered by said piston in said predetermined range and is covered when said piston-has moved a predetermined distance from said end position.

2. An accumulator according to claim 1, wherein a low-pressure chamber receives hydraulic fluid that is discharged from at least one outlet port.

3. An accumulator according to claim 1, wherein the liner around the pressure chamber is made of a polymeric material, such as poly phenylene sulfide.

4. An accumulator according to claim 2, wherein a passage is provided in order to interconnect the low-pressure chamber with a low-pressure side of the accumulator.

5. An accumulator according to claim 2, wherein a passage is provided in order to interconnect with the low-pressure chamber with a reservoir.

6. An accumulator according to claim 1, further comprising a spring at a low pressure side of the accumulator, for biasing the piston towards a top end position in the pressure chamber.

7. An accumulator according to claim 1 further comprising a drain of a control component, which drain is connected to a low-pressure side of the accumulator.

8. An accumulator according to claim 1, further comprising a spillway overflow at a low-pressure side of the accumulator between an interior of the accumulator and a channel leading to a reservoir.

9. An accumulator according to claim 1, wherein the at least one outlet port has a diameter that is smaller than a width of a piston ring of the piston.

10. A hydraulic system comprising a hydraulic pump, a control component and a hydraulic actuator, wherein the system further comprises an accumulator according to claim 1.

11. An all-wheel drive coupling comprising a hydraulic system according to claim 10.
